(19) United States
(12) Patent Application Publication
(10) Pub. No.: US 2007/0237875 A1
(43) Pub. Date: Oct. 11, 2007

(54) Energy spread

(76) Inventors: Anahid Soulikhan, Burbank, CA (US); Lida Soulikhan, Burbank, CA (US)

Correspondence Address: NATHANIEL GORDON-CLARK, 1025 NORTH CALVERT STREET, BALTIMORE, MD, 21202, US

(21) Appl. No.: 11/784,657

(22) Filed: Apr. 9, 2007

Related U.S. Application Data
(60) Provisional application No. 60/790,706, filed on Apr. 10, 2006.

(51) Int. Cl. A23C 15/00

(52) U.S. Cl. 426/581; 426/615

(57) ABSTRACT

An energy spread made by the combination of dates and a fat. The preferred embodiment envisions a combination of dates and butter with the content of butter being slightly higher by weight than the content of dates. The energy spread is intended to be added to other previously prepared foods to increase energy content and nutrition content.

### CROSS-REFERENCE TO RELATED APPLICATIONS

This application claims the benefit of Provisional Patent Application Ser. No. 60/790,706, filed Apr. 10, 2006 by the present inventors.

### FEDERALLY SPONSORED RESEARCH

None

### SEQUENCE LISTING OR PROGRAM

None

### FIELD OF INVENTION

This invention relates to food. More specifically it relates to energy foods. Even more specifically it relates to energy foods that can be added to other foods.

### BACKGROUND OF THE INVENTION

A number of energy foods exist on the market today. Theses foods are intended to supply the user with energy for physical activity and also supply nutrients that might otherwise be lacking in high-energy foods. These foods also contain multiple types of energy so that the energy in the food is released in a controlled manner that allows for the maximum efficiency in absorption by the human body.

These foods are usually a self-contained food that cannot be added to any other food. Thus these foods cannot be used to improve another food item.

Furthermore, substances that are usually added to foods to increase the energy or nutritious value of the food are usually adding during the cooking process. Often specialized equipment is required to add these substances. This invention is a means of added to the energy and nutritious value of any food after the food items has already been prepared and completed.

### PURPOSE OF THE INVENTION

Energy spread is a food product developed for multiple uses. This nutritious date and butter spread can be eaten for breakfast, used as a filling between biscuits as a quick snack, eaten with cooked rice, or mixed with raw egg. In addition, this sweet treat can be used as an ice cream or yogurt flavoring. This type of spread cannot currently be found on any supermarket shelf.

### PROBLEMS THE INVENTION SOLVES

Today, everyone is on the go and moving at a hectic pace. This spread is nutritious, tasty, and fast to prepare and consume. In addition, it is very inexpensive. The energy spread is designed so that it can improve the energy and nutritious value of another food. Unlike food additives, the energy spread can be added to an existing food item with the need for cooking or special equipment.

### SUMMARY OF INVENTION

The invention is a food that has a high nutrition value with a high-energy content. The invention combines a natural sugar with a fat. The sugar is the sugar from dates. The dates add both fiber and nutrients to the food. The preferred embodiment of the invention envisions a combination of butter and dates into a smooth spread. Low fat butter and fresh dates are an ideal combination for this purpose, but other butters or other dates could be used.

This spread is inexpensive and easy to prepare. The dates and the fat are combined in any way that reduces the mixture to an approximately smooth texture. The intention of the invention is that it can be added to other foods to increase the nutrition and energy content of the other food. Since the invention is an energy spread, it can be added to other finished food products, without requiring cooking or equipment by the user.

The preferred embodiment envisions butter as the fat source. The invention is prepared by cutting the butter and the dates into small pieces, and then putting them into a mixer. The mixture is mixed until the mixture becomes cream-like and is able to be spread. A person skilled in the art will see that adding coloring, preservatives or other additives will not change the mixture of dates and butter.

Dates contain a wide range of essential nutrients and provide potential health benefits and medicinal value. Dates are low in calories and contain protein, and mineral products. They are high in fiber and an ideal source of potassium. The recommendation of the National Cancer Institute is to eat a minimum of five servings of fruit and vegetables daily as part of a low fat, high fiber diet to help reduce the risk of some types of cancer. A handful of dates will help consumers meet that goal. Five or six dates provide 3 grams of dietary fiber.

The Energy spread has both a sugar and a fat component. The 29 grams of naturally occurring sugars in a serving of dates provides quick energy and are readily assimilated into and used by the body. This makes dates a perfect choice as an energy-boosting snack. These sugars are added to a fat source that supplies longer lasting energy. It is well known that the energy from fat is greater than the energy from sugars. Sugar has 4 Cal for each gram, while fat has 9 Cal for each gram. It is also well known that the energy from fats take a longer time to digest and release than the energy from sugars. Thus the energy from the energy spread first is absorbed as a quick burst from sugar to revitalize the body and then takes form of a slow release energy from fat that continuous to supply the body with energy.

### DETAILED DESCRIPTION OF THE PREFERRED EMBODIMENT

The preferred embodiment of the Energy spread is made from unsalted, sweet butter (4 oz, 113 grams) and seedless dates (4.16 oz, 118 grams). In the preferred embodiment 4 oz of butter are used for each 4.16 oz of dates. Alternatively, 113 grams of butter are used for each 118 grams of dates. Alternatively, the preferred embodiment is a mixture of 48.9% butter to 51.1% dates, by weight. Cut the butter and seedless dates into small pieces, and then put them into a mixer. Mix until the mixture becomes cream-like and is able to be spread.

Although this invention has been illustrated by reference to specific embodiments, it will be apparent to those skilled in the art that various changes and modification may be made which clearly fall within the scope of the invention. The invention is intended to be protected broadly within the spirit and scope of the appended claims.

What is claimed is:

1. An energy spread comprising a mixture of dates and fats.

2. The energy spread of claim 1 where the fat is butter.

3. The energy spread of claim 1 where the mixture of fat to dates is approximately equal.

4. The energy spread of claim 1 where the ratio of fat to dates is 113 to 118, respectively, by weight.

5. The energy spread of claim 1 where the ratio of fat to dates is 48.9% to 51.1%, respectively, by weight.

6. An energy spread comprising a mixture of dates and butter.

7. The energy spread of claim 8 where the ratio of butter to dates is 113 to 118, respectively, by weight.

9. The energy spread of claim 1 where the ratio of butter to dates is 48.9% to 51.1%, respectively, by weight.

10. An energy spread comprising a mixture of dates and butter in a ratio of 113 grams of butter for each 118 grams of dates.
